(19) United States
(12) Patent Application Publication
(10) Pub. No.: US 2007/0231742 A1
(43) Pub. Date: Oct. 4, 2007

(54) Optical Information-Recording Medium

(75) Inventors: Kousuke Watanabe, Kanagawa (JP); Tetsuya Watanabe, Kanagawa (JP); Keita Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, TOKYO (JP)

(21) Appl. No.: 11/632,066

(22) PCT Filed: Jun. 22, 2006
(86) PCT No.: PCT/JP06/12932

§ 371 Date: Jan. 10, 2007

(30) Foreign Application Priority Data
Jun. 22, 2005 (JP) P2005-182439

(51) Int. Cl. G11B 7/24

(52) U.S. Cl. 430/270.14

(57) ABSTRACT

An optical information-recording medium comprises a recording layer comprising an oxonol dye represented by formula (1), and its counter cation is a cyanine cation: 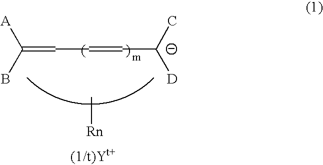
wherein A, B, C and D each represents an electron attractive group, wherein sum total of Hammett's σp values of A and B, and sum total of Hammett's σp values of C and D are respectively 0.6 or more, and A and B, or C and D may be linked with each other to make a ring; R represents a substituent on carbon of methine; m represents an integer of 0 or 1; n represents an integer of 0 to 2m+1, and when n represents an integer of 2 or more, plural R's may be the same or different, and they may be linked with each other to form a ring; Y^{t+} represents a t-valent cyanine cation; and t represents an integer of 1 to 10.

### TECHNICAL FIELD

The present invention relates to an information-recording medium capable of recording and reproducing information with a laser beam, an information-recording method, and a novel compound suitable for the medium. In particular, the invention relates to a heat mode type optical information-recording medium suitable for recording information with short wave laser beams of wavelengths of from 400 to 410 nm.

### BACKGROUND ART

An optical information-recording medium capable of recording information with laser beams for one time only (optical disc) is conventionally known. This optical disc is also called a direct read after write CD (so-called CD-R), and the representative structure comprises a transparent disc-like substrate having provided thereon in order of a recording layer comprising a methine dye, a light reflective layer comprising a metal, e.g., gold, and a protective layer comprising a resin in laminated state. Recording of information on CD-R is performed by irradiation of CD-R with a laser beam of near infrared region (generally laser beams of wavelengths in the vicinity of 780 nm), the irradiated area of the recording layer absorbs the light and the temperature locally increases, thus physical or chemical change (e.g., formation of a pit) is caused, thereby optical characteristics are changed and the information is recorded. On the other hand, reading (reproduction) of the information is also performed by irradiation with a laser beam having the same wavelength as the laser beam for recording, and the information is reproduced by the detection of the difference in reflectance between the area where the optical characteristics are changed (a recorded area) and the area where the optical characteristics are not changed (an unrecorded area) in the recording layer.

In recent years, network such as Internet and high vision TV have been rapidly spread. Further, televising of HDTV (High Definition Television) is approaching, so that the requirement for high capacity recording media to inexpensively and easily record image information is increasing. Although CD-R and DVD-R that made high density recording possible by using visible laser beams (from 630 to 680 nm) as lasers for recording have secured the position as high capacity recording media to a certain degree, it cannot be said that they have sufficiently high recording capacity capable of responding to the demand in future. Therefore, the development of optical discs having higher recording capacity has been advanced by using laser beams of shorter wavelengths than DVD-R to thereby improve recording density, and an optical recording disc called a Blue-ray system using a blue laser of, e.g., 405 nm has been now on the market.

In CD-R type optical discs, as the dye compounds contained in the recording layer, dyes having absorption in the near infrared region, e.g., dicarbocyanine dyes having a benzoindolenine skeleton (having five methine chains) and tricarbocyanine dyes (having seven methine chains) are conventionally advantageously used (e.g., JP-A-64-40382 and JP-A-64-40387).

In general, cyanine dyes and oxonol dyes alone are low in light fastness and recording characteristics are deteriorated, and as a means for improving the drawback, a method of using the compounds as disclosed in JP-A-58-175693, a method of using an organic oxidant as the counter salt of each dye as disclosed in JP-A-10-151861, and the techniques in JP-A-10-324065 and JP-A-10-109475 are known. However, although the techniques of improving the light fastness in DVD-R are known, there are no specific examples until now as the means of maintaining high light fastness in optical recording discs corresponding to blue laser using oxonol dyes. It is necessary to grasp the light fastness in optical recording discs corresponding to blue laser using oxonol dyes, and to examine the improvement in light fastness.

A compound having a bipyridinium salt as the counter cation of an oxonol dye is disclosed in JP-A-10-2971.03, and there is disclosed the effect of a bipyridinium-salt imparting light fastness to an oxonol dye, but further improvement in light fastness is required.

### DISCLOSURE OF THE INVENTION

The present inventors performed comparative examination of the performance of a compound using cyanine as the counter cation of an oxonol dye as in the invention and a compound using a bipyridinium ion in manufacturing the optical recording disc using a blue laser of 405 nm. As a result, it was found that better light fastness and better solubility could be surprisingly obtained from the compound having cyanine as the counter cation of the invention.

Further, the present inventors found that the solubility of dyes and dissolution stability by aging could be improved by using the compound in the invention without influencing recording characteristics and preservation stability, thus the invention has been achieved.

An object of the invention is to provide an optical information-recording medium corresponding to blue laser beams not impairing recording/reproducing characteristics, and improved in light fastness, durability, and solubility, and another object is to provide a recording method of information using the same.

The above objects of the invention have been preferably achieved by the following constitution.

(1) An optical information-recording medium comprising: a substrate; and a recording layer capable of recording of information by irradiation with laser beams of wavelengths of from 400 to 410 nm, wherein the recording layer contains an oxonol dye represented by formula (1), and a counter cation of the oxonol dye (i.e., Y^{t+} in formula (1)) is a cyanine cation: 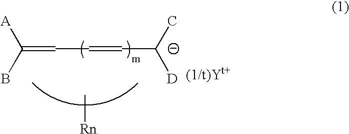
wherein A, B, C and D each represents an electron attractive group, wherein the sum total of Hammett's σp values of A and B, and the sum total of Hammett's σp values of C and D are respectively 0.6 or more, and A and B, or C and D may be linked with each other to make a ring; R represents a substituent on carbon of methine; m represents an integer of 0 or 1; n represents an integer of from 0 to 2m+1, and when n represents an integer of 2 or more, a plurality of R's may be the same or different, and they may be linked with each other to form a ring; Y^{t+} represents a t-valent cyanine cation; and t represents an integer of from 1 to 10.

(2) The optical information-recording medium as described in the above item (1), wherein the oxonol dye is represented by formula (2): 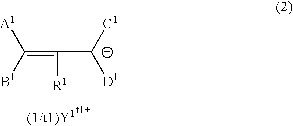
wherein A¹, B¹, C¹ and D¹ each represents an electron attractive group, wherein the sum total of Hammett's σp values of A¹ and B¹, and the sum total of Hammett's σp values of C¹ and D¹ are respectively 0.6 or more, and A¹ and B¹, or C¹ and D¹ may be linked with each other to make a ring; R¹ represents a hydrogen atom or a substituent on the carbon of methine; Y^{1t1+} represents a t1-valent cyanine cation; and t1 represents an integer of from 1 to 10.

(3) The optical information-recording medium as described in the item (1) or (2), wherein the cyanine cation is represented by formula (3) or (4): 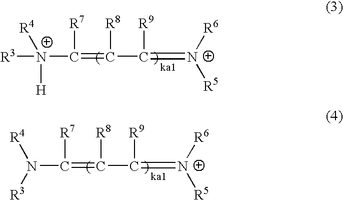
in formulae (3) and (4), R³ to R⁹ each represents a hydrogen atom or a substituent, and R³ to R⁹ may be linked with each other to form a ring; and ka1 represents an integer of from 0 to 3, and when ka1 is 2 or more, a plurality of R⁸'s and R⁹'s may be the same or different.

(4) The optical information-recording medium as described in the item (1) or (2), wherein the cyanine cation is represented by formula (5): 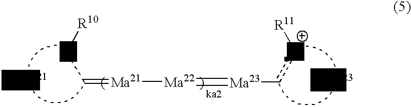
wherein Za²¹ and Za²² each independently represents an atomic group to form a heterocyclic ring; Ma²¹, Ma²² and Ma²³ each independently represents a substituted or unsubstituted methine group; ka2 represents an integer of from 0 to 3, and when ka is 2 or more, a plurality of Ma²¹'s and Ma²²'s may be the same or different; and R¹⁰ and R¹¹ each independently represents a substituent.

(5) The optical information-recording medium as described in the item (1), (2) or (4), wherein the cyanine cation represented by formula (5) is represented by formula (6): 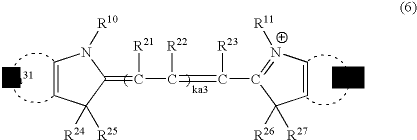
wherein Za³¹ and Za³² each independently represents an atomic group to form a carbocyclic ring or a heterocyclic ring; R¹⁰ and R¹¹ have the same meaning as R¹⁰ and R¹¹ in formula (5); R²¹, R²², R²³, R²⁴R²⁵, R²⁶ and R²⁷ each represents a hydrogen atom or a substituent; and ka3 represents an integer of from 0 to 3, and when ka3 is 2 or more, a plurality of R²¹'s and R²²'s may be the same or different.

(6) The optical information-recording medium as described in any of the items (1) to (5), further comprising a light reflective layer comprising a metal.

(7) The optical information-recording medium as described in any of the items (1) to (6), further comprising a protective layer.

(8) The optical information-recording medium as described in any of the items (1) to (7), wherein the substrate is a transparent disc-like substrate having a pre-groove having the track pitch of from 0.2 to 0.5 μm on the surface of the transparent disc-like substrate, and the recording layer is provided on the surface of the side on which the pre-groove is provided.

(9) The oxonol dye represented by formula (2) as described in the item (2), wherein the cyanine cation is the oxonol dye represented by formula (3) as described in the item (3).

(10) The oxonol dye represented by formula (2) as described in the item (2), wherein the cyanine cation is the oxonol dye represented by formula (5) as described in the item (4).

### BEST MODE FOR CARRYING OUT THE INVENTION

The invention relates to an optical information-recording medium comprising a substrate having thereon a recording layer capable of recording of information by irradiation with laser beams of from 400 to 410 nm.

Oxonol dyes are described below. Oxonol dyes are defined in the invention as polymethine dyes having anionic chromophores. An oxonol dye represented by the following formula (1) is especially preferably used for its excellent recording characteristics.

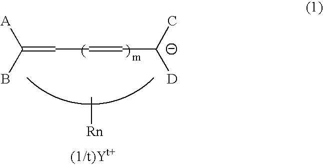

In formula (1), A, B, C and D each represents an electron attractive group, wherein the sum total of Hammett's up values of A and B, and the sum total of Hammett's σp values of C and D are respectively 0.6 or more, and A and B, or C and D may be linked with each other to make a ring; R represents a substituent on the carbon of methine; m represents an integer of from 0 to 3; n represents an integer of from 0 to 2m+1, and when n represents an integer of 2 or more, a plurality of R's may be the same or different, and they may be linked with each other to form a ring; Y^{t+} represents a t-valent cation; and t represents an integer of from 1 to 10.

Formula (1) includes a plurality of tautomers due to difference in expression of local positions of anions. In particular, when any of A, B, C and D is —CO-E (E is a substituent), it is general expression to localize negative electric charge on the oxygen atom. For example, when D represents —CO-E, the following formula (7) is general as the expression, and this expression is also included in formula (1).

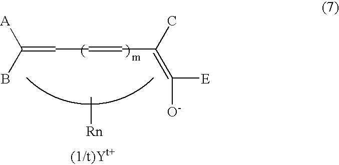

A, B, C, R, m, n, Y^{t+} and t in formula (7) are the same as those in formula (1). E represents a substituent as described above. As the examples of E, an alkyl group, an alkoxyl group or an aryl group are preferably exemplified.

An oxonol dye represented by formula (1) is described below. In formula (1), A, B, C and D each represents an electron attractive group, wherein the sum total of Hammett's substitution constant up values of A and B, and the sum total of Hammett's substitution constant σp values of C and D are respectively 0.6 or more. A, B, C and D may be the same or different from each other. A and B, or C and D may be linked with each other to make a ring. Hammett's substitution constant σp value of the electron attractive group represented by A, B, C or D is preferably in the range of from 0.30 to 0.85, and more preferably in the range of from 0.35 to 0.80.

Hammett's substitution constant σp value (hereinafter referred to as a σp value) is described, e.g., in Chem. Rev., 91, 165 (1991) and the reference literatures quoted therein, and those not described can also be found according to the method described in the literature. When A and B (C and D) are linked and forming a ring, the σp value of A(C) means the σp value of an -A-B—H(—C-D-H) group, and the σp value of B(D) means the σp value of a —B-A-H(-D-C—H) group. In this case, both are different in the direction of bonding, so that the σp values are different.

The preferred examples of the electron attractive groups represented by A, B, C and D include a cyano group, a nitro group, an acyl group having from 1 to 10 carbon atoms (e.g., acetyl, propionyl, butyryl, pivaloyl, benzoyl), an alkoxy-carbonyl group having from 2 to 12 carbon atoms (e.g., methoxycarbonyl, ethoxycarbonyl, isopropoxycarbonyl, butoxy-carbonyl, decyloxycarbonyl), an aryloxycarbonyl group having from 7 to 11 carbon atoms (e.g., phenoxycarbonyl), a carbamoyl group having from 1 to 10 carbon atoms (e.g., methylcarbamoyl, ethylcarbamoyl, phenylcarbamoyl), an alkylsulfonyl group having from 1 to 10 carbon atoms (e.g., methanesulfonyl), an arylsulfonyl group having from 6 to 10 carbon atoms (e.g., benzenesulfonyl), an alkoxysulfonyl group having from 1 to 10 carbon atoms (e.g., methoxysulfonyl), a sulfamoyl group having from 1 to 10 carbon atoms (e.g., ethylsulfamoyl, phenyl-sulfamoyl), an alkylsulfinyl group having from 1 to 10 carbon atoms (e.g., methanesulfinyl, ethanesulfinyl), an aryl-sulfinyl group having from 6 to 10 carbon atoms (e.g., benzenesulfinyl), an alkylsulfenyl group having from 1 to 10 carbon atoms (e.g., methanesulfenyl, ethanesulfenyl), a halogen atom, an alkynyl group having from 2 to 10 carbon atoms (e.g., ethynyl), a diacylamino group having from 2 to 10 carbon atoms (e.g., diacetylamino), a phosphoryl group, a carboxyl group, and a 5- or 6-membered heterocyclic group (e.g., 2-benzothiazolyl, 2-benzoxazoly, 3-pyridyl, 5-(1H)tetrazolyl, 4-pyrimidyl). Among them, a 5- or 6-membered heterocyclic group is preferred.

As the examples of the substituents on the methine carbon represented by R in formula (1), e.g., the following groups can be exemplified: a chain or cyclic alkyl group having from 1 to 20 carbon atoms (e.g., methyl, ethyl, n-propyl, isopropyl, n-butyl), a substituted or unsubstituted aryl group having from 6 to 18 carbon atoms (e.g., phenyl, chlorophenyl, anisyl, toluoyl, 2,4-di-t-amyl, 1-naphthyl), an alkenyl group (e.g., vinyl, 2-methylvinyl), an alkynyl group (e.g., ethynyl, 2-methylethynyl, 2-phenylethynyl), a halogen atom (e.g., F, Cl, Br, I), a cyano group, a hydroxyl group, a carboxyl group, an acyl group (e.g., acetyl, benzoyl, salicyloyl, pivaloyl), an alkoxyl group (e.g., methoxy, butoxy, cyclohexyloxy), an aryloxy group (e.g., phenoxy, 1-naphthoxy), an alkylthio group (e.g., methylthio, butylthio, benzylthio, 3-methoxypropyl-thio), an arythio group (e.g., phenylthio, 4-chlorophenyl-thio), an alkylsulfonyl group (e.g., methanesulfonyl, butanesulfonyl), an arylsulfonyl group (e.g., benzenesulfonyl, paratoluenesulfonyl), a carbamoyl group having from 1 to 10 carbon atoms, an amido group having from 1 to 10 carbon atoms, an imido group having from 2 to 12 carbon atoms, an acyloxy group having from 2 to 10 carbon atoms, an alkoxycarbonyl group having from 2 to 10 carbon atoms, a heterocyclic group (e.g., aromatic heterocyclic ring, e.g., pyridyl, thienyl, furyl, thiazolyl, imidazolyl, pyrazolyl, etc., and aliphatic heterocyclic ring, e.g., pyrrolidine, piperidine, morpholine, pyran, thiopyran, dioxane, dithiolan, etc.).

R preferably represents a halogen atom, a chain or cyclic alkyl group having from 1 to 8 carbon atoms, an aryl group having from 6 to 10 carbon atoms, an alkoxyl group having from 1 to 8 carbon atoms, an aryloxy group having from 6 to 10 carbon atoms, or a heterocyclic group having from 3 to 10 carbon atoms, and particularly preferably represents a chlorine atom, an alkyl group having from 1 to 4 carbon atoms (e.g., methyl, ethyl, isopropyl), phenyl, an alkoxyl group having from 1 to 4 carbon atoms (e.g., methoxy, ethoxy, phenoxy), a nitrogen-containing heterocyclic group having from 4 to 8 carbon atoms (e.g., 4-pyridyl, benzoxazol-2-yl, benzothiazol-2-yl).

n represents an integer of from 0 to 2m+1, and when n represents an integer of 2 or more, a plurality of R's may be the same or different, and they may be linked with each other to form a ring. At this time, the member of the ring is preferably 4 to 8, and especially preferably 5 or 6. The constituting atom of the ring is preferably a carbon atom, an oxygen atom or a nitrogen atom, and especially preferably a carbon atom.

A, B, C, D and R may further have a substituent, e.g., the same groups as described above as the examples of the monovalent substituents represented by R in formula (1) are exemplified as the substituents.

As the dyes for use in optical discs, it is preferred for A and B, or C and D, to be linked with each other to form a ring from the viewpoint of thermal decomposition.

As the examples of the substituents represented by E in formula (7), the same groups as those represented by A, B, C and D can be exemplified, and the preferred range is also the same.

As the specific examples of the anion sites of the oxonol dye represented by formula (1) for use in the invention, the anion sites of the oxonol dyes disclosed in JP-A-10-297103 can be exemplified, and the following compounds can also be exemplified as specific examples, but the invention is not restricted to these compounds.

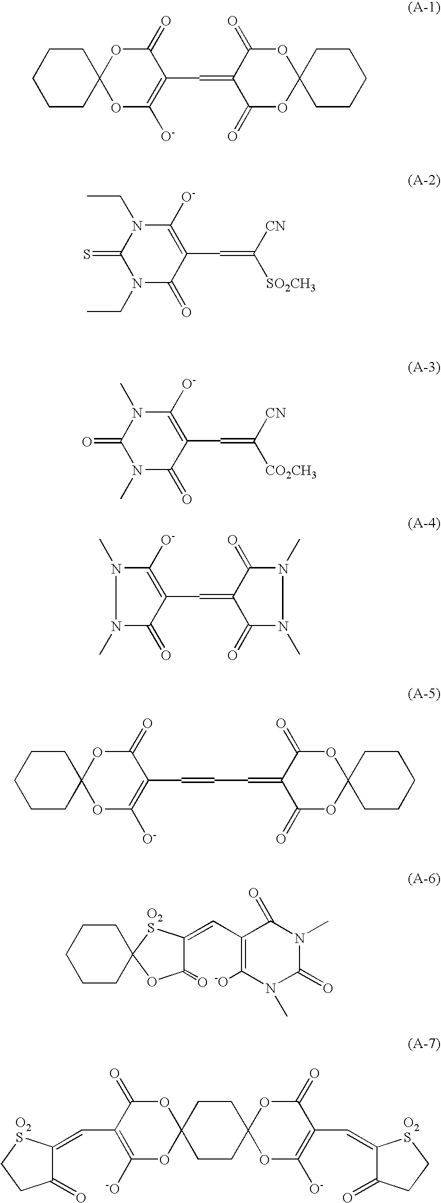

Formula (1) is Preferably Represented by Formula (2).

Formula (2) is explained. A¹, B¹, C¹ and D¹ have the same meaning as A, B, C and D described above, and the preferred range is also the same.

R¹ has the same meaning as R above, and the preferred range is also the same.

t1 has the same meaning as t above, and the preferred range is also the same.

Y¹ has the same meaning as Y above, and the preferred range is also the same.

The cyanine (compound) of cyanine cation is explained. As the cyanine, the compounds described in The Chemistry of Heterocyclic Compound, “Cyanine Dyes and Related Compounds”, John Wiley & Sons, New York, London (1964) can be exemplified.

The cyanine cation in the invention shall include those provided with H⁺ on the N atom of cyanine as the cation represented by formula (3).

Cyanine cation is preferably represented by formula (3), (4) or (5), more preferably represented by formula (3) or (4), and still more preferably represented by formula (4).

Formulae (3) and (4) are described. ka1 represents an integer of from 0 to 3, and preferably 0.

R³ to R⁹ each represents a hydrogen atom or a substituent. As the examples of the substituents, a substituted or unsubstituted alkyl group, a substituted or unsubstituted aryl group, a substituted or unsubstituted alkenyl group, and a substituted or unsubstituted alkynyl group are exemplified. These groups may further be substituted, and as the examples of the substituents, the same groups as the groups represented by R above can be exemplified. R³ to R⁶ each preferably represents a substituted or unsubstituted alkyl group, more preferably a substituted or unsubstituted alkyl group having from 1 to 8 carbon atoms, and still more preferably an unsubstituted alkyl group having from 1 to 8 carbon atoms. R⁷ to R⁹ may be different from each other, but they are preferably the same. R⁷ to R⁹ preferably represent a hydrogen atom. R³ to R⁹ may be linked with each other to form a ring. For example, when ka1 is 1, R⁵ or R⁶ can be rinked with R⁷ to form a 4-pyridine ring. Further, when ka1 is 3, R³ and R⁹, or R⁵ and R⁹ can be linked with each other to form a 4-pyridine ring or a 4-quiniline ring.

The specific examples of the cyanines having a structure represented by formula (3) or (4) used in the invention are shown below, however, the invention is not restricted to these specific examples.

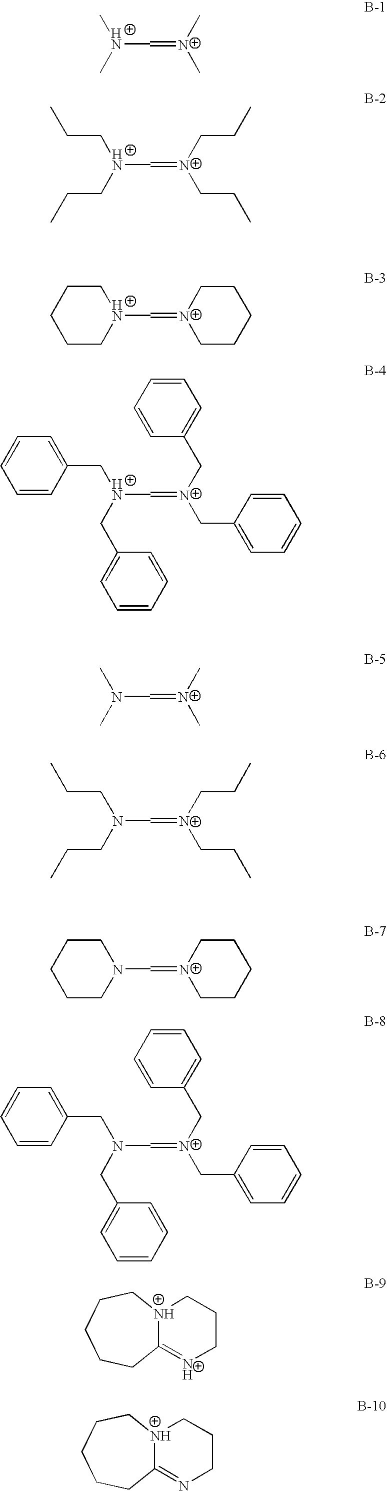

A dye represented by formula (5) is described below.

Ma²¹, Ma²² and Ma²³ each represents a substituted or unsubstituted methine group. As the substituents substituted for Ma²¹, Ma²² and Ma²³, the same groups as the groups represented by R above are exemplified. Ma²¹, Ma²² and Ma²³ each preferably represents a methine group substituted with an unsubstituted alkyl group having from 1 to 5 carbon atoms, an unsubstituted alkoxyl group having from 1 to 5 carbon atoms, a substituted or unsubstituted aryl group having from 2 to 6 carbon atoms or a halogen atom, or an unsubstituted methine group.

R¹⁰ and R¹¹ each represents a substituted or unsubstituted alkyl group, a substituted or unsubstituted aryl group, a substituted or unsubstituted alkenyl group, or a substituted or unsubstituted alkynyl group. These groups may further be substituted. As the examples of the substituents, the same groups as the groups represented by R above can be exemplified. R¹⁰ and R¹¹ each preferably represents a substituted or unsubstituted alkyl group, more preferably a substituted or unsubstituted alkyl group having from 1 to 8 carbon atoms, and still more preferably an unsubstituted alkyl group having from 1 to 8 carbon atoms. R¹⁰ and R¹¹ may be different from each other, but they are preferably the same.

ka2 represents an integer of from 0 to 3, preferably 1 or 2, and more preferably 2. When ka2 is 2 or more, a plurality of Ma²¹'s and Ma²²'s may be the same or different.

Za²¹ and Za²² each represents an atomic group to form a substituted or unsubstituted heterocyclic group having from 2 to 20 carbon atoms. The heterocyclic rings represented by Za²¹ and Za²² are not especially restricted, but a pyrrole ring, an imidazole ring, an oxazole ring, a thiazole ring, a pyridine ring (the bonding position to the methine group may be not only the 2-position but also the 4-position), condensed rings containing these rings (e.g., benzpyrrole), and tautomers of these rings are preferred, a pyrrole ring, an imidazole ring, an oxazole ring, a thiazole ring, and condensed rings containing these rings are more preferred, a pyrrole ring, an oxazole ring, a thiazole ring, and condensed rings containing these rings are still more preferred, and a pyrrole ring and a condensed ring thereof are especially preferred.

Formula (5) is preferably represented by formula (6).

Formula (6) is described below. Za³¹ and Za³² each represents a carbocyclic ring or a heterocyclic ring. The carbocyclic rings and the heterocyclic rings are not especially restricted, but a substituted or unsubstituted benzene ring having from 6 to 20 carbon atoms, and condensed rings thereof are preferred.

R¹⁰ and R¹¹ in formula (6) have the same meaning as R¹⁰ and R¹¹ in formula (5), and the preferred range is also the same.

R²¹, R²² and R²³ each represents a hydrogen atom or a substituent. As the examples of the substituents, the same groups as those represented by R are exemplified. The examples of the substituents include preferably a hydrogen atom, an unsubstituted alkyl group having from 1 to 5 carbon atoms, an unsubstituted alkoxyl group having from 1 to 5 carbon atoms, a substituted or unsubstituted aryl group having from 2 to 10 carbon atoms, and a halogen atom, more preferably a hydrogen atom, an unsubstituted alkyl group having from 1 to 5 carbon atoms, and a substituted or unsubstituted aryl group having from 2 to 10 carbon atoms, and still more preferably a hydrogen atom.

R²⁴ to R²⁷ each represents a hydrogen atom or a substituent. As the examples of the substituents, the same groups as the groups represented by R above are exemplified, preferably a substituted or unsubstituted alkyl group, more preferably a substituted or unsubstituted alkyl group having from 1 to 8 carbon atoms, and still more preferably an unsubstituted alkyl group having from 1 to 8 carbon atoms.

ka3 has the same meaning as ka2, and the preferred range is also the same.

The specific examples of the cyanines having a structure represented by formula (6) are shown below, but the invention is not restricted to these specific examples.

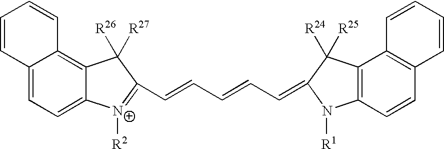

| | R¹ | R² | R²⁴ | R²⁵ | R²⁶ | R²⁷ |
|---|---|---|---|---|---|---|
| C-1 | —CH₃ | —CH₃ | —CH₃ | —CH₃ | —CH₃ | —CH₃ |
| C-2 | —C₂H₅ | —C₂H₅ | —CH₃ | —CH₃ | —CH₃ | —CH₃ |
| C-3 | —C₃H₇⁽ⁿ⁾ | —C₃H₇⁽ⁿ⁾ | —CH₃ | —CH₃ | —CH₃ | —CH₃ |
| C-4 | —C₄H₉⁽ⁿ⁾ | —C₄H₉⁽ⁿ⁾ | —CH₃ | —CH₃ | —CH₃ | —CH₃ |
| C-5 | —C₄H₉⁽ⁿ⁾ | —CH₃ | —CH₃ | —CH₃ | —CH₃ | —CH₃ |
| C-6 | —CH₃ | —CH₃ | —CH₃ | —C₃H₇⁽ⁿ⁾ | —CH₃ | —C₃H₇⁽ⁿ⁾ |
| C-7 | —CH₃ | —C₄H₉⁽ⁿ⁾ | —CH₃ | —CH₃ | —CH₃ | —CH₃ |
| C-8 | —CH₃ | 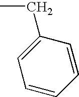 | —CH₃ | —CH₃ | —CH₃ | —CH₃ |
| C-9 | —CH₃ | —CH₃ | —CH₃ | —CH₃ | —CH₃ | —CH₃ |
| C-10 | —C₂H₅ | —C₂H₅ | —CH₃ | —CH₃ | —CH₃ | —CH₃ |
| C-11 | —C₃H₇⁽ⁿ⁾ | —C₃H₇⁽ⁿ⁾ | —CH₃ | —CH₃ | —CH₃ | —CH₃ |
| C-12 | —C₄H₉⁽ⁿ⁾ | —C₄H₉⁽ⁿ⁾ | —CH₃ | —CH₃ | —CH₃ | —CH₃ |
| C-13 | —C₄H₉⁽ⁿ⁾ | —CH₃ | —CH₃ | —CH₃ | —CH₃ | —CH₃ |
| C-14 | —CH₃ | —CH₃ | —CH₃ | —C₂H₅ | —CH₃ | —C₂H₅ |
| C-15 | —CH₃ | —C₄H₉⁽ⁿ⁾ | —CH₃ | —CH₃ | —CH₃ | —CH₃ |
| C-16 | —CH₃ | 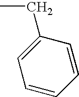 | —CH₃ | —CH₃ | —CH₃ | —CH₃ |
| C-17 | —CH₃ | —CH₃ | —CH₃ | —C₂H₅ | —CH₃ | —CH₃ |
| C-18 | —C₂H₅ | —C₂H₅ | —CH₃ | —CH₃ | —CH₃ | —CH₃ |
| C-19 | —C₃H₇⁽ⁿ⁾ | —C₃H₇⁽ⁿ⁾ | —CH₃ | —CH₃ | —CH₃ | —CH₃ |
| C-20 | —C₄H₉⁽ⁿ⁾ | —C₄H₉⁽ⁿ⁾ | —CH₃ | —CH₃ | —CH₃ | —CH₃ |
| C-21 | —C₄H₉⁽ⁿ⁾ | —CH₃ | —CH₃ | —CH₃ | —CH₃ | —CH₃ |
| C-22 | —CH₃ | —CH₃ | —CH₃ | —C₃H₇⁽ⁿ⁾ | —CH₃ | —C₃H₇⁽ⁿ⁾ |
| C-23 | —CH₃ | —C₄H₉⁽ⁿ⁾ | —CH₃ | —CH₃ | —CH₃ | —CH₃ |
| C-24 | —CH₃ | 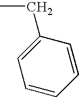 | —CH₃ | —CH₃ | —CH₃ | —CH₃ |
| C-25 | —C₄H₉ | —C₂H₅ | —CH₃ | —C₂H₅ | —CH₃ | —CH₃ |
| C-26 | —C₂H₅ | —C₂H₅ | —CH₃ | —CH₃ | —CH₃ | —CH₃ |
| C-27 | —C₃H₇⁽ⁿ⁾ | —C₃H₇⁽ⁿ⁾ | —CH₃ | —CH₃ | —CH₃ | —CH₃ |
| C-28 | —C₄H₉⁽ⁿ⁾ | —C₄H₉⁽ⁿ⁾ | —CH₃ | —CH₃ | —CH₃ | —CH₃ |
| C-29 | —C₄H₉⁽ⁿ⁾ | —CH₃ | —CH₃ | —CH₃ | —CH₃ | —CH₃ |
| C-30 | —CH₃ | —CH₃ | —CH₃ | —C₃H₇⁽ⁿ⁾ | —CH₃ | —C₃H₇⁽ⁿ⁾ |
| C-31 | —CH₃ | —C₄H₉⁽ⁿ⁾ | —CH₃ | —CH₃ | —CH₃ | —CH₃ |
| C-32 | —CH₃ | 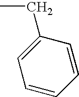 | —CH₃ | —CH₃ | —CH₃ | —CH₃ |
| C-33 | —CH₃ | —CH₃ | —CH₃ | —CH₃ | —CH₃ | —CH₃ |
| C-34 | —C₂H₅ | —C₂H₅ | —CH₃ | —CH₃ | —CH₃ | —CH₃ |
| C-35 | —C₃H₇⁽ⁿ⁾ | —C₃H₇⁽ⁿ⁾ | —CH₃ | —CH₃ | —CH₃ | —CH₃ |
| C-36 | —C₄H₉⁽ⁿ⁾ | —C₄H₉⁽ⁿ⁾ | —CH₃ | —CH₃ | —CH₃ | —CH₃ |
| C-37 | —C₄H₉⁽ⁿ⁾ | —CH₃ | —CH₃ | —CH₃ | —CH₃ | —CH₃ |
| C-38 | —CH₃ | —CH₃ | —CH₃ | —C₃H₇⁽ⁿ⁾ | —CH₃ | —C₃H₇⁽ⁿ⁾ |
| C-39 | —CH₃ | —C₄H₉⁽ⁿ⁾ | —CH₃ | —CH₃ | —CH₃ | —CH₃ |
| C-40 | —CH₃ | 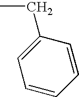 | —CH₃ | —CH₃ | —CH₃ | —CH₃ |

The following compounds can also be exemplified as cyanines.

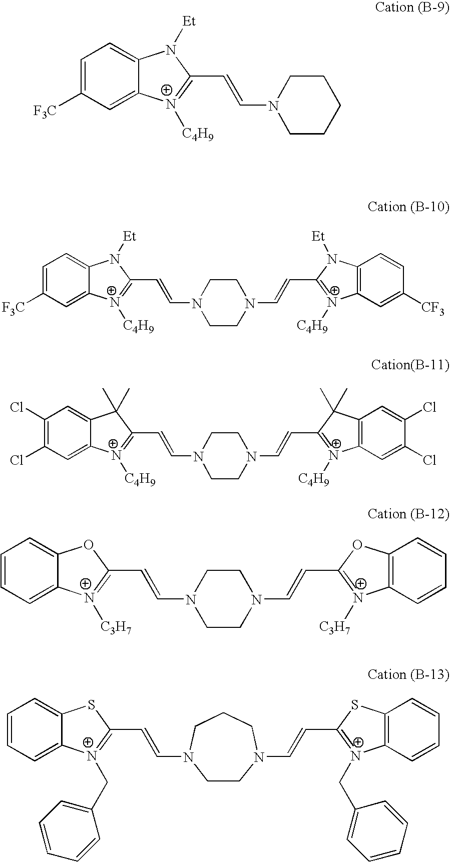

The combinations of oxonol (anion site) with cyanine (cation site) are preferably (oxonol/cyanine) of [formula (2)/formula (3)], [formula (2)/formula (4)], [formula (2)/formula (5)], and [formula (2)/formula (6)], more preferably (oxonol/cyanine) of [formula (2)/formula (3)], [formula (2)/formula (4)], and [formula (2)/formula (5)], still more preferably (oxonol/cyanine) of [formula (2)/formula (3)] and [formula (2)/formula (4)], and especially preferably (oxonol/cyanine) of [formula (2)/formula (4)].

The specific examples of formula (1) are shown in Table 1-1 to 1-5 below, but the invention is not restricted thereto.

TABLE 1-1

| | Anion Site of | | |
|---|---|---|---|
| Compound | Oxonol Dye | Cyanine | t |
| Compound (1) | (A-1) | (B-1) | 2 |
| Compound (2) | (A-1) | (B-2) | 2 |
| Compound (3) | (A-6) | (B-5) | 1 |
| Compound (4) | (A-6) | (B-2) | 2 |
| Compound (5) | (A-6) | (B-7) | 1 |
| Compound (6) | (A-6) | (C-26) | 1 |
| Compound (14) | (A-1) | (B-10) | 1 |

TABLE 1-2

| | Anion Site of | | |
|---|---|---|---|
| Compound | Oxonol Dye | Cyanine | t |
| Compound 2-1 | (A-2) | (B-1) | 2 |
| Compound 2-2 | (A-2) | (B-2) | 2 |
| Compound 2-3 | (A-2) | (B-3) | 2 |
| Compound 2-4 | (A-2) | (B-5) | 1 |
| Compound 2-5 | (A-2) | (B-8) | 1 |
| Compound 2-6 | (A-2) | (B-9) | 2 |
| Compound 2-7 | (A-2) | (C-1) | 1 |
| Compound 2-8 | (A-2) | (C-9) | 1 |
| Compound 2-9 | (A-2) | (C-17) | 1 |
| Compound 2-10 | (A-2) | (C-26) | 1 |
| Compound 2-11 | (A-2) | (C-33) | 1 |

TABLE 1-3

| | Anion Site of | | |
|---|---|---|---|
| Compound | Oxonol Dye | Cyanine | t |
| Compound 3-1 | (A-3) | (B-1) | 2 |
| Compound 3-2 | (A-3) | (B-2) | 2 |
| Compound 3-3 | (A-3) | (B-3) | 2 |
| Compound 3-4 | (A-3) | (B-5) | 1 |
| Compound 3-5 | (A-3) | (B-8) | 1 |
| Compound 3-6 | (A-3) | (B-9) | 2 |
| Compound 3-7 | (A-3) | (C-1) | 1 |
| Compound 3-8 | (A-3) | (C-9) | 1 |
| Compound 3-9 | (A-3) | (C-17) | 1 |
| Compound 3-10 | (A-3) | (C-26) | 1 |
| Compound 3-11 | (A-3) | (C-33) | 1 |

TABLE 1-4

| | Anion Site of | | |
|---|---|---|---|
| Compound | Oxonol Dye | Cyanine | t |
| Compound 4-1 | (A-4) | (B-1) | 2 |
| Compound 4-2 | (A-4) | (B-2) | 2 |
| Compound 4-3 | (A-4) | (B-3) | 2 |
| Compound 4-4 | (A-4) | (B-5) | 1 |
| Compound 4-5 | (A-4) | (B-8) | 1 |
| Compound 4-6 | (A-4) | (B-9) | 2 |
| Compound 4-7 | (A-4) | (C-1) | 1 |
| Compound 4-8 | (A-4) | (C-9) | 1 |
| Compound 4-9 | (A-4) | (C-17) | 1 |
| Compound 4-10 | (A-4) | (C-26) | 1 |
| Compound 4-11 | (A-4) | (C-33) | 1 |

TABLE 1-5

| | Anion Site of | | |
|---|---|---|---|
| Compound | Oxonol Dye | Cyanine | t |
| Compound 5-1 | (A-5) | (B-1) | 2 |
| Compound 5-2 | (A-5) | (B-2) | 2 |
| Compound 5-3 | (A-5) | (B-3) | 2 |
| Compound 5-4 | (A-5) | (B-5) | 1 |
| Compound 5-5 | (A-5) | (B-8) | 1 |
| Compound 5-6 | (A-5) | (B-9) | 2 |
| Compound 5-7 | (A-5) | (C-1) | 1 |
| Compound 5-8 | (A-5) | (C-9) | 1 |
| Compound 5-9 | (A-5) | (C-17) | 1 |
| Compound 5-10 | (A-5) | (C-26) | 1 |
| Compound 5-11 | (A-5) | (C-33) | 1 |

Optical Information-Recording Medium:

The optical information-recording medium in the invention is preferably:

### Embodiment (1)

An optical information-recording medium comprising a substrate having a thickness of from 0.7 to 2 mm having thereon in order of a direct read after write recording layer containing a dye, and a cover layer having a thickness of from 0.01 to 0.5 mm

### Embodiment (2)

An optical information-recording medium comprising a substrate having a thickness of from 0.1 to 1.0 mm having thereon in order of a direct read after write recording layer containing a dye, and a protective layer having a thickness of from 0.1 to 1.0 mm

In embodiment (1), it is preferred that the pre-groove formed on the substrate has the track pitch of from 50 to 500 nm, the width of the groove of from 25 to 250 nm, and the depth of the groove of from 5 to 150 nm. In embodiment (2), it is preferred that the pre-groove formed on the substrate has the track pitch of from 200 to 600 nm, the width of the groove of from 50 to 300 nm, the depth of the groove of from 30 to 200 nm, and wobble amplitude of from 10 to 50 nm.

The optical information-recording medium in embodiment (1) comprises at least a substrate, a direct read after write recording layer, and a cover layer. In the first place, these essential members are described in order.

Substrate in Embodiment (1):

It is essential that the substrate in preferred embodiment (1) should be provided with a pre-groove (a guide groove) having the form in which all of track pitch, groove width (half value width), groove depth, and wobble amplitude satisfy the following ranges. The pre-groove is formed to achieve higher recording density as compared with that of CD-R and DVD-R. The pre-groove is suitable, for example, when the optical information-recording medium of the invention is used as a medium corresponding to blue violet lasers.

It is essential that the track pitch of the pre-groove be in the range of from 200 to 500 nm, preferably the least upper bound value of the track pitch is 420 nm or less, more preferably 370 nm or less, and still more preferably 330 nm or less. Further, the greatest lower bound value is preferably 260 nm or more.

When the track pitch is less than 200 nm, it is difficult to accurately form a pre-groove and, further, a problem of cross talk is liable to occur, and when the track pitch exceeds 500 nm, there are cases where recording density lowers.

It is essential that the groove width (a half value width) of the pre-groove be in the range of from 25 to 250 nm, preferably the least upper bound value is 200 nm or less, more preferably 170 nm or less, and still more preferably 150 nm or less. Further, the greatest lower bound value is preferably 50 nm or more, more preferably 80 nm or more, and still more preferably 100 nm or more.

When the groove width of the pre-groove is less than 25 nm, the groove cannot be sufficiently transferred in molding, or a recording error rate increases. While when the groove width exceeds 250 nm, the pit formed in recording widens, which sometimes causes cross talk or insufficient degree of modulation.

It is essential that the groove depth of the pre-groove be in the range of from 5 to 150 nm, preferably the least upper bound value is 100 nm or less, more preferably 70 nm or less, and still more preferably 50 nm or less. Further, the greatest lower bound value is preferably 10 nm or more, more preferably 20 nm or more, and still more preferably 28 nm or more.

When the groove depth of the pre-groove is less than 5 nm, there are cases where sufficient degree of recording modulation cannot be obtained, and when it exceeds 150 nm, reflectance sometimes greatly lowers.

The least upper bound value of the inclination angle of the groove of the pre-groove is preferably 80° or less, more preferably 70° or less, still more preferably 60° or less, and especially preferably 50° or less. Further, the greatest lower bound value is preferably 20° or more, more preferably 30° or more, and still more preferably 40° or more.

When the inclination angle of the groove of the pre-groove is less than 20°, there are cases where sufficient amplitude of tracking error signals cannot be obtained, and when the inclination angle exceeds 80°, molding is difficult.

As the substrates for use in the invention, various kinds of materials conventionally used as the substrate materials of optical information-recording media can be optionally selected and used.

Specifically, glass; acrylic resins, e.g., polycarbonate, polymethyl methacrylate, etc.; vinyl chloride resins, e.g., polyvinyl chloride, vinyl chloride copolymers, etc.; epoxy resins; amorphous polyolefin; polyester; and metals, e.g., aluminum, etc., can be exemplified, and, if necessary, these materials may be used in combination.

In view of moisture resistance, dimensional stability and inexpensiveness, thermoplastic resins such as amorphous polyolefin, polycarbonate, etc., are preferred of these materials, and polycarbonate is especially preferred.

When these resins are used, a substrate can be manufactured by injection molding.

The thickness of the substrate is necessary to be in the range of from 0.7 to 2 mm, preferably in the range of from 0.9 to 1.6 mm, and more preferably in the range of from 1.0 to 1.3 mm.

It is preferred to provide an undercoat layer on the surface of the substrate on which a light reflective layer described later is provided for the purpose of the improvement in flatness and adhesion.

As the materials of the undercoat layer, polymeric substances, e.g., polymethyl methacrylate, acrylic acid-methacrylic acid copolymers, styrene-maleic acid anhydride copolymers, polyvinyl alcohol, N-methylolacrylamide, styrene-vinyltoluene copolymers, chlorosulfonated polyethylene, nitrocellulose, polyvinyl chloride, chlorinated polyolefin, polyester, polyimide, vinyl acetate-vinyl chloride copolymers, ethylene-vinyl acetate copolymers, polyethylene, polypropylene, polycarbonate, etc., and a surface improver, e.g., a silane coupling agent can be exemplified.

The undercoat layer can be formed by dissolving or dispersing these materials in a proper solvent to prepare a coating solution, and then coating the coating solution on the surface of the substrate by appropriate coating method, e.g., spin coating, dip coating or extrusion coating, etc. The thickness of the undercoat layer is generally from 0.005 to 20 μm, and preferably from 0.01 to 10 μM.

Direct Read after Write Recording Layer in Embodiment (1):

Direct read after write recording layer in preferred embodiment (1) is formed by dissolving a dye in a proper solvent together with a binder, etc., to prepare a coating solution, and then coating the coating solution on a substrate or a light reflective layer described later to thereby form a film, and they drying. The direct read after write recording layer may be a monolayer or multilayer, and in the case of a multilayer structure, process of coating the coating solution is carried out a plurality of times.

The concentration of dye in a coating solution is generally in the range of from 0.01 to 15 mass %, preferably from 0.1 to 10 mass %, more preferably from 0.5 to 5 mass %, and most preferably from 0.5 to 3 mass %.

As the solvents for a coating solution, esters, e.g., butyl acetate, ethyl lactate and cellosolve acetate; ketones, e.g., methyl ethyl ketone, cyclohexanone and methyl isobutyl ketone; chlorinated hydrocarbons, e.g., dichloromethane, 1,2-dichloroethane and chloroform; amides, e.g., dimethyl-formamide; hydrocarbons, e.g., methylcyclohexane; ethers, e.g., tetrahydrofuran, ethyl ether and dioxane; alcohols, e.g., ethanol, n-propanol, isopropanol, and n-butanol diacetone alcohol; fluorine solvents, e.g., 2,2,3,3-tetrafluoro-propanol; and glycol ethers, e.g., ethylene glycol monomethyl ether, ethylene glycol monoethyl ether, propylene glycol monomethyl ether can be exemplified.

These solvents can be used alone or two or more in combination considering the solubility of the dyes to be used. Further, various additives such as an antioxidant, a UV absorber, a plasticizer, a lubricant and the like can be added to the coating solution.

As the coating methods, a spray coating method, a spin coating method, a dip coating method, a roll coating method, a blade coating method, a doctor roll coating method, and a screen printing method can be exemplified.

The temperature of a coating solution in coating is preferably in the range of from 20 to 50° C., more preferably from 23 to 40° C., and especially preferably from 23 to 37° C.

The thickness of the thus formed direct read after write recording layer on the groove (the convex part of the foregoing substrate) is preferably 300 nm or less, more preferably 250 nm or less, still more preferably 200 nm or less, and especially preferably 180 nm or less. The greatest lower bound value is preferably 30 nm or more, more preferably 50 nm or more, still more preferably 70 nm or more, and especially preferably 90 nm or more.

The thickness of the thus formed direct read after write recording layer on the land (the concave part of the foregoing substrate) is preferably 400 nm or less, more preferably 300 nm or less, and still more preferably 250 nm or less. The greatest lower bound value is preferably 70 nm or more, more preferably 90 nm or more, and still more preferably 110 nm or more.

Further, the ratio of the thickness of the direct read after write recording layer on the groove/the thickness of the direct read after write recording layer on the land is preferably 0.4 or more, more preferably 0.5 or more, still more preferably 0.6 or more, and especially preferably 0.7 or more. The least upper bound value of the ratio is preferably less than 1, more preferably 0.9 or less, still more preferably 0.85 or less, and especially preferably 0.8 or less.

When the coating solution contains a binder, the examples of the binders include natural organic polymeric substances, e.g., gelatin, cellulose derivatives, dextran, rosin, rubber, etc.; synthetic organic polymers, such as precondensates of thermosetting resins, such as hydrocarbon resins, e.g., polyethylene, polypropylene, polystyrene, polyisobutylene, etc., vinyl resins, e.g., polyvinyl chloride, polyvinylidene chloride, polyvinyl chloride/polyvinyl acetate copolymers, etc., acrylic resins, e.g., polymethyl acrylate, polymethylmethacrylate, etc., polyvinyl alcohol, chlorinated polyethylene, epoxy resins, butyral resins, rubber derivatives, phenol/formaldehyde resins, etc. When a binder is used in combination as the material of a direct read after write recording layer, the use amount of the binder is generally in the range of from 0.01 to 50 times (mass ratio) the amount of the dye, and preferably from 0.1 to 5 time (mass ratio) the amount of the dye.

For the purpose of the further improvement in light fastness of a direct read after write recording layer, the direct read after write recording layer can contain various kinds of discoloration inhibitors. As the discoloration inhibitors, singlet oxygen quenchers are generally used. By the use of singlet oxygen quenchers as mixture, further elevation in light fastness can be expected also in the invention. The singlet oxygen quenchers disclosed in the following patent literatures can be used in the invention.
JP-A-58-175693
JP-A-59-81194
JP-A-60-18387
JP-A-60-19586
JP-A-60-19587
JP-A-60-35054
JP-A-60-36190
JP-A-60-36191
JP-A-44554
JP-A-44555
JP-A-44389
JP-A-60-44390
JP-A-60-54892
JP-A-60-47069
JP-A-63-209995
JP-A-4-25492
JP-B-1-38680
JP-B-6-26028
German Patent 350,399
Nippon Kagaku Kai-Shi (Bulletin of Chemical Society of Japan), the October number, p. 1141 (1992)

The use amount of discoloration inhibitors, such as the above singlet oxygen quenchers, is generally in the range of from 0.1 to 50 mass % to the amount of the dye, preferably in the range of from 0.5 to 45 mass %, more preferably in the range of from 3 to 40 mass %, and especially preferably in the range of from 5 to 25 mass %.

Cover Layer in Embodiment (1):

The cover layer in preferred embodiment (1) is stuck on the direct read after write recording layer or on a barrier layer described later through an adhesive or a pressure-sensitive adhesive.

The cover layers for use in the invention are not especially restricted so long as they are the films of transparent materials, but it is preferred to use acrylic resins, e.g., polycarbonate, polymethyl methacrylate, etc.; vinyl chloride resins, e.g., polyvinyl chloride, vinyl chloride copolymers, etc.; epoxy resins; amorphous polyolefin; polyester; or cellulose triacetate, and it is more preferred to use polycarbonate or cellulose triacetate.

The term “transparent” means that the transmittance to the light used in recording or reproduction is 80% or more.

Further, the cover layer may contain various kinds of additives so long as the effect of the invention is not hindered. For example, UV absorbers for cutting the light of wavelength of 400 nm or lower and/or dyes for cutting the light of 500 nm or higher may be contained.

In addition, as the surface physical characteristics of the cover layer, it is preferred that the surface roughness of both two-dimensional parameter and three-dimensional parameter is 5 nm or lower.

Further, the birefringence of the cover layer is preferably 10 nm or less from the viewpoint of the converging of the light used in recording and reproduction.

The thickness of the cover layer is arbitrarily prescribed in accordance with the wavelengths and NA of the laser beams irradiated for recording and reproduction, but in the invention the thickness is preferably in the range of from 0.01 to 0.5 mm, and more preferably in the range of from 0.05 to 0.12 mm.

The total thickness of the cover layer and the layer comprising an adhesive or a pressure-sensitive adhesive is preferably from 0.09 to 0.11 mm, and mare preferably from 0.095 to 0.105 mm.

Incidentally, a protective layer (a hard coat layer) may be provided on the light incident surface of the cover layer in order to prevent the light incident surface from being scratched in the manufacture of the optical information-recording medium.

As abrasives that are used to stick the cover layer, it is preferred to use, e.g., UV-curable resins, EB-curable resins and thermosetting resins, and UV-curable resins are especially preferably used.

When UV-curable resins are used as the abrasives, a coating solution may be prepared with the UV-curable resins as they are, or they are dissolved in a proper solvent, e.g., methyl ethyl ketone, ethyl acetate, and the like, and the obtained coating solution may be fed to the surface of a barrier layer with a dispenser. It is preferred that the UV-curable resin constituting an adhesive layer has a small curing shrinkage factor in order to prevent warpage of the optical information-recording medium to be manufactured. As such a UV-curable resin, e.g., UV-curable resin SD-640 (manufactured by Dainippon Ink and Chemicals Inc.) can be exemplified.

It is preferred to coat a prescribed amount of the adhesive on the surface of, e.g., a barrier layer to be stuck, put the cover layer thereon, and then spread the adhesive between the surface to be stuck and the cover layer uniformly by spin coating and cure the adhesive.

The range of the thickness of the adhesive layer comprising the adhesive is preferably from 0.1 to 100 μm, more preferably from 0.5 to 50 μm, and still more preferably from 10 to 30 μm.

As the adhesives to be used for sticking the cover layer, acrylic, rubber and silicon adhesives can be used, but in the points of transparency and durability, acrylic adhesives are preferably used. As such acrylic adhesives, it is preferred to use copolymers comprising 2-ethylhexyl acrylate or n-butyl acrylate as the main component, short chain alkyl acrylate or methacrylate, e.g., methyl acrylate, ethyl acrylate, or methyl methacrylate, for improving cohesive force, and, as the component capable of becoming a crosslinking point with a crosslinking agent, acrylic acid, methacrylic acid, acrylamide derivative, maleic acid, hydroxyethyl acrylate, or glycidyl acrylate. It is possible to change glass transition temperature (Tg) and crosslinking density by properly regulating the mixing ratios and kinds of main components, short chain components, and components to add crosslinking point.

As the crosslinking agents that are used in combination with the above adhesives, e.g., isocyanate crosslinking agents are exemplified. As the isocyanate crosslinking agents, isocyanates, e.g., tolylene diisocyanate, 4,4′-diphenyl-methane diisocyanate, hexamethylene diisocyanate, xylylene diisocyanate, naphthylene-1,5-diisocyanate, o-toluidine isocyanate, isophorone diisocyanate, and triphenylmethane triisocyanate, the products of these isocyanates with polyalcohols, and polyisocyanates formed by condensation of isocyanates can be used. As commercially available products of these isocyanates, Coronate L, Coronate HL, Coronate 2030, Coronate 2031, Millionate MR, Millionate HTL (manufactured by Nippon Polyurethane Industry Co., Ltd.), Takenate D-102, Takenate D-110N, Takenate D-200, Takenate D-202 (manufactured by Takeda Chemical Industries, Ltd.), Desmodur L, Desmodur IL, Desmodur N, Desmodur HL (manufactured by Sumitomo Bayer Co., Ltd.) can be exemplified.

The adhesive may be coated in a prescribed amount on the surface of a barrier layer to be stuck and, after putting the cover layer thereon, cured, or an adhesive coated film may be prepared in advance by coating a prescribed amount of the adhesive uniformly on one side of the cover layer, and the coated film may be stuck on the surface of a barrier layer to be stuck and cured.

Alternatively, commercially available adhesive films previously provided with an adhesive layer may be used for the cover layer.

The thickness of the adhesive layer comprising such an adhesive is preferably in the range of from 0.1 to 100 μm, more preferably in the range of from 0.5 to 50 μm, and still more preferably in the range of from 10 to 30 μm.

Other Layers in Embodiment (1):

The optical information-recording medium in preferred embodiment (1) may have other optional layers in addition to the above essential layers so long as the effect of the invention is not hindered. As such other optional layers, for example, a label layer having a desired image formed on the reverse of the substrate (with the side having the direct read after write recording layer as the obverse), a light reflective layer (which layer is described later) provided between the substrate and the direct read after write recording layer, a barrier layer (which layer is described later) provided between the direct read after write recording layer and the cover layer, and an interfacial layer provided between the light reflective layer and the direct read after write recording layer can be exemplified. The label layer is formed with UV-curable resins, thermosetting resins or thermo-drying resins.

Incidentally, these essential and optional layers may take a monolayer or multilayer structure.

Light Reflective Layer in Embodiment (1):

In the optical information-recording medium in preferred embodiment (1), it is preferred to provide a light reflective layer between the substrate and the direct read after write recording layer for the purpose of increasing the reflectance to laser beams and improving recording and reproducing characteristics.

The light reflective layer can be formed on a substrate by vacuum evaporation, sputtering, or ion plating of light reflective substances having high reflectance to laser beams.

The thickness of the light reflective layer is generally in the range of from 10 to 300 nm, and preferably in the range of from 50 to 200 nm.

Incidentally, the reflectance is preferably 70% or more.

As light reflective substances having high reflectance, metals, e.g., Mg, Se, Y, Ti, Zr, Hf, V, Nb, Ta, Cr, Mo, W, Mn, Re, Fe, Co, Ni, Ru, Rh, Pd, Ir, Pt. Cu, Ag, Au, Zn, Cd, Al, Ga, In, Si, Ge, Te, Pb, Po, Sn, Bi, etc., metalloids, and stainless steel can be exemplified. The light reflective substances may be used alone, combination of two or more, or as alloys. The preferred substances of these are Cr, Ni, Pt, Cu, Ag, Au, Al, and stainless steel. Au, Ag, Al, and alloys of these metals are particularly preferred, and Au, Ag, and alloys of these metals are most preferred.

Forming Process of Barrier Layer (Intermediate Layer) in Embodiment (1):

In the optical information-recording medium in preferred embodiment (1), it is preferred to provide a barrier layer between the direct read after write recording layer and the cover layer.

The barrier layer is provided for the purpose of increasing the preservation stability of the direct read after write recording layer, improving the adhesion of the direct read after write recording layer and the cover layer, adjusting reflectance, adjusting heat conductivity, and the like.

The materials for use in the barrier layer are not especially restricted so long as they are materials capable of transmitting light for recording and reproduction and exhibiting the above functions, but generally the materials are preferably low in permeability of gas and moisture, and dielectric substances.

Specifically, materials comprising nitride, oxide, carbide or sulfide of Zn, Si, Ti, Te, Sn, Mo, Ge, etc., are preferred. ZnS, MoO₂, GeO₂, TeO, SiO₂, TiO₂, ZuO, ZnS—SiO₂, SnO₂, ZnO—Ga₂O₃ are preferred, and ZnS—SiO₂, SnO₂, ZnO—Ga₂O₃ are more preferred.

The barrier layer can be formed by vacuum film-forming methods such as vacuum evaporation, DC sputtering, RF sputtering, and ion plating. It is more preferred to use sputtering, and using RF sputtering is still more preferred.

The thickness of the barrier layer is preferably in the range of from 1 to 200 nm, more preferably in the range of from 2 to 100 nm, and still more preferably in the range of from 3 to 50 nm.

In the next place, the optical information-recording medium in preferred embodiment (2) is described.

The optical information-recording medium in embodiment (2) is an optical information-recording medium having a sticking type layer structure, and the representative layer structures are as follows.

(1) The first layer structure is a structure comprising a substrate having formed thereon in order of a direct read after write recording layer, a light reflective layer, and an adhesive layer, and providing a protective substrate on the adhesive layer.

(2) The second layer structure is a structure comprising a substrate having formed thereon in order of a direct read after write recording layer, a light reflective layer, a protective layer, an adhesive layer, and providing a protective substrate on the adhesive layer.

(3) The third layer structure is a structure comprising a substrate having formed thereon in order of a direct read after write recording layer, a light reflective layer, a protective layer, an adhesive layer, a protective layer, and providing a protective substrate on the protective layer.

(4) The fourth layer structure is a structure comprising a substrate having formed thereon in order of a direct read after write recording layer, a light reflective layer, a protective layer, an adhesive layer, a protective layer, and a light reflective layer, and providing a protective substrate on the light reflective layer.

(5) The fifth layer structure is a structure comprising a substrate having formed thereon in order of a direct read after write recording layer, a light reflective layer, an adhesive layer, a light reflective layer, and providing a protective substrate on the light reflective layer.

The above layer structures (1) to (5) are mere examples, and the layer structures are not only the above orders but also apart may be replaced, or a part may be omitted. Further, a direct read after write recording layer may also be formed on the protective substrate side, and in that case, the resulting optical information-recording medium can be recorded and reproduced from both sides. Further, each layer may comprise a single layer or may comprise a plurality of layers.

The optical information-recording medium in the invention is explained below taking a medium having a structure comprising a substrate having in order of a direct read after write recording layer, a light reflective layer, an adhesive layer, and a protective substrate as an example.

Substrate in Embodiment (2):

It is essential that the substrate in preferred embodiment (2) should be provided with a pre-groove (a guide groove) having the form in which all of track pitch, groove width (half value width), groove depth, and wobble amplitude satisfy the following ranges. The pre-groove is formed to achieve higher recording density as compared with that of CD-R and DVD-R. The pre-groove is suitable, for example, when the optical information-recording medium of the invention is used as a medium corresponding to blue violet lasers.

It is essential that the track pitch of the pre-groove be in the range of from 200 to 500 nm, preferably the least upper bound value of the track pitch is 450 nm or less, and more preferably 430 nm or less. Further, the greatest lower bound value is preferably 300 nm or more, more preferably 330 nm or more, and still more preferably 370 nm or more.

When the track pitch is less than 200 nm, it is difficult to accurately form a pre-groove and, further, a problem of cross talk is liable to occur, and when the track pitch exceeds 500 nm, there are cases where recording density lowers.

It is essential that the groove width (a half value width) of the pre-groove be in the range of from 50 to 300 nm, preferably the least upper bound value is 250 nm or less, more preferably 200 nm or less, and still more preferably 180 nm or less. Further, the greatest lower bound value is preferably 100 nm or more, more preferably 120 nm or more, and still more preferably 140 nm or more.

When the groove width of the pre-groove is less than 50 nm, the groove cannot be sufficiently transferred in molding, or a recording error rate increases. While when the groove width exceeds 300 nm, the pit formed in recording widens, which sometimes causes cross talk or insufficient degree of modulation.

It is essential that the groove depth of the pre-groove be in the range of from 30 to 200 nm, preferably the least upper bound value is 170 nm or less, more preferably 140 nm or less, and still more preferably 120 nm or less. Further, the greatest lower bound value is preferably 40 nm or more, more preferably 50 nm or more, and still more preferably 60 nm or more.

When the groove depth of the pre-groove is less than 30 nm, there are cases where sufficient degree of recording modulation cannot be obtained, and when it exceeds 200 nm, reflectance sometimes greatly lowers.

As the substrate for use in preferred embodiment (2), various kinds of materials conventionally used as the substrate materials of optical information-recording media can be optionally selected and used, and the specific examples and the preferred examples of the materials are the same as the substrate in embodiment (1).

The thickness of the substrate is necessary to be in the range of from 0.1 to 1.0 mm, preferably in the range of from 0.2 to 0.8 mm, and more preferably in the range of from 0.3 to 0.7 mm.

It is preferred to provide an undercoat layer on the surface of the substrate on which a direct read after write recording layer described later is provided for the purpose of the improvement in flatness and adhesion. The specific examples and the preferred examples of the materials, coating methods and thickness of the undercoat layer are the same as those of the undercoat layer described in embodiment (1).

Direct Read after Write Recording Layer in Embodiment (2):

The detailed description of the direct read after write recording layer in preferred embodiment (2) is the same as that of the direct read after write recording layer in embodiment (1)

Light Reflective Layer in Embodiment (2):

In preferred embodiment (2), there are cases where a light reflective layer is formed on the direct read after write recording layer in order to heighten the reflectance to laser beams or impart the function of improving recording and reproducing characteristics. The details of the light reflective layer in embodiment (2) are the same as those of the light reflective layer in embodiment (1).

Adhesive Layer in Embodiment (2):

An adhesive layer in preferred embodiment (2) is an optional layer that is formed for the purpose of improving the adhesion of the light reflective layer and a protective substrate.

The materials for constituting the adhesive layer are preferably photo-curable resins, and for preventing warpage of the disc, materials having a small curing shrinkage factor are preferred. As such photo-curable resins, e.g., UV-curable resins (UV-curable adhesives) SD-640 and SD-347 (manufactured by Dainippon Ink and Chemicals Inc.) can be exemplified. For giving elasticity, the thickness of the adhesive layer is preferably in the range of from 1 to 1,000 μm.

Protective Substrate in Embodiment (2):

As a protective substrate (a dummy substrate) in preferred embodiment (2), the same material and the same form as those of the substrate can be used. The thickness of the protective substrate is necessary to be in the range of from 0.1 to 1.0 mm, preferably in the range of from 0.2 to 0.8 mm, and more preferably in the range of from 0.3 to 0.7 mm.

Protective Layer in Embodiment (2):

According to the layer constitution, there are cases where the optical information-recording medium in preferred embodiment (2) is provided with a protective layer for the purpose of physically and chemically protecting the light reflective layer and the direct read after write recording layer.

As the examples of the materials for the protective layer, inorganic substances, e.g., ZnS, ZnS—SiO₂, SiO, SiO₂, MgF₂, SnO₂, Si₃N₄, etc., and organic substances, e.g., thermoplastic resins, thermosetting resins, UV-curable resins, etc., can be exemplified.

The protective layer can be formed, for example, by sticking a film obtained by extrusion processing of plastics on the light reflective layer via an adhesive. The protective layer may be provided by methods of vacuum evaporation, sputtering, or coating.

When thermoplastic resins or thermosetting resins are used as the protective layer, the protective layer can also be formed by dissolving the resins in a proper solvent to prepare a coating solution, and coating the coating solution and drying. In a case of UV-curable resins, the protective layer can be formed by preparing a coating solution with the UV-curable resins as they are, or dissolving the resins in a proper solvent, coating the obtained coating solution, irradiating with UV rays to thereby cure the coated layer. To the coating solution may further be added various additives, e.g., an antistatic agent, an antioxidant, a UV absorber, etc, according to purposes.

The thickness of the protective layer is generally in the range of from 0.1 μm to 1 mm.

Other Layers in Embodiment (2):

The optical information-recording medium in preferred embodiment (2) may have other optional layers in addition to the above layers so long as the effect of the invention is not hindered. The detailed description of other optional layers is the same as other layers in embodiment (1).

Optical Information-Recording Method:

Optical information recording in the invention is carried out, for example, as follows with the optical information-recording medium in preferred embodiment (1) or (2). Light for recording, e.g., semiconductor laser beam and the like, is irradiated from the substrate side or the protective layer side while rotating the optical information-recording medium at a constant linear velocity (0.5 to 10 m/sec) or a constant angle velocity. It is thought that the recording layer absorbs irradiated light and temperature rises locally, as a result physical or chemical change (e.g., formation of a pit) occurs to thereby change the optical characteristics of the recording layer, and the information is recorded. In the invention, semiconductor laser beams having oscillation wavelengths of the range of from 390 to 450 nm are used as recording light. As preferred light sources, blue violet semiconductor laser beams in the range of from 390 to 415 nm, and blue violet SHG laser beams having central oscillation wavelength of 425 nm obtained by halving infrared semiconductor laser beam having central oscillation wavelength of 850 nm with a photoconductive wave cell can be exemplified. It is especially preferred to use blue violet semiconductor laser beams having oscillation wavelengths in the range of from 390 to 415 nm in view of recording density. Reproduction of the recorded information as above can be performed by rotating the optical information-recording medium at the same constant linear velocity as above and irradiating semiconductor laser beam from the substrate side or the protective layer side, and detecting the reflected light.

### EXAMPLE

The invention will be described in further detail with reference to examples, but the invention is not restricted to the examples.

The examples of the synthesis methods of the oxonol dyes in the invention are shown below.
Synthesis of Compound (1):

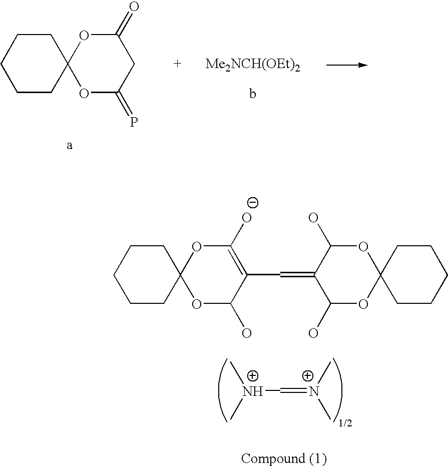

Compound a (5.6 g) was stirred in ethanol, and 5.3 ml of Compound b was dripped thereto. The reaction solution was allowed to react at room temperature for 5 hours, and the solvent was removed under reduced pressure. The resulting solution was purified with silica gel column chromatography, and 0.5 g of compound (1) was obtained.
Synthesis of Compound (6):

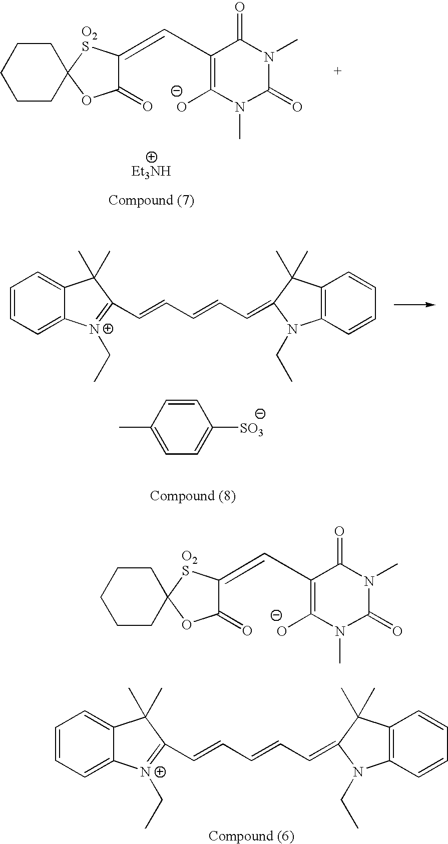

Compound (6) can be obtained by refluxing Compound (7) and Compound (8) in alcohol with heating.

### Example 1

Manufacture of Optical Information-Recording Medium 1:

Manufacture of Substrate:

A substrate comprising a polycarbonate resin having a thickness of 1.1 mm, an outer diameter of 120 mm, an inner diameter of 15 mm, and a spiral pre-groove (track pitch: 320 nm, groove width: on groove width of 120 nm, groove depth: 35 nm, inclination angle of groove: 65°, wobble amplitude: 20 nm) was manufactured by injection molding. Mastering of the stamper used in injection molding was performed with razor cutting (351 nm).

Formation of Light Reflective Layer:

An APC light reflective layer (Ag: 98.1 mas %, Pd: 0.9 mass %, Cu: 1.0 mass %) of a vacuum evaporated film having a thickness of 100 nm was formed on the substrate by DC sputtering in the Ar atmosphere with Cube (manufactured by Unaxis Co.). The thickness of the light reflective layer was adjusted by sputtering time.

Formation of Direct Read after Write Recording Layer:

A dye-containing coating solution was prepared by dissolving 0.2 g of Compound (1) or (6) shown in Table 1-1 in 10 ml of 2,2,3,3-tetrafluoropropanol. The prepared dye-containing coating solution was coated on the light reflective layer by spin coating by changing the speed of rotation from 300 to 4,000 rpm on the conditions of 23° C., 50% RH. After that, the layer was preserved at 23° C., 50% RH for 1 hour, whereby a direct read after write recording layer (thickness on the groove: 120 nm, thickness on the land: 170 nm) was formed.

After forming the direct read after write recording layer, the substrate was subjected to annealing treatment in a clean oven. The annealing treatment was performed at 80° C. for 1 hour by supporting the substrates with perpendicular stack poles at intervals with spacers.

Formation of Barrier Layer:

Subsequently, a barrier layer comprising ZnO—Ga₂O₃ (ZnO/Ga₂O₃: 7/3 in mass ratio) having a thickness of 5 nm was formed on the direct read after write recording layer by RF sputtering in the Ar atmosphere with Cube (manufactured by Unaxis Co.).

Sticking of Cover Layer:

As the cover layer, a polycarbonate film (Teijin Pure Ace, thickness: 80 μm) having an inner diameter of 15 mm, an outer diameter of 120 mm, and coated with an adhesive on one side was used. The total thickness of the polycarbonate film and the adhesive layer was set to be 100 μm.

The cover layer was put on the barrier layer so that the barrier layer and the adhesive layer were brought into contact, and the cover layer was stuck on the barrier layer by pressure with a pressing member.

Thus, optical information-recording media in Examples 1 and 2 and Comparative Examples 1 and 2 were manufactured.

As comparative compounds, compounds disclosed in JP-A-10-297103, that is compounds having a bipyridinium cation as a counter cation were used. Compounds (A) to (G) were used in Comparative Examples 1 to 7, respectively. In addition, the compounds of the invention used in the examples 3 to 6 are as follows. 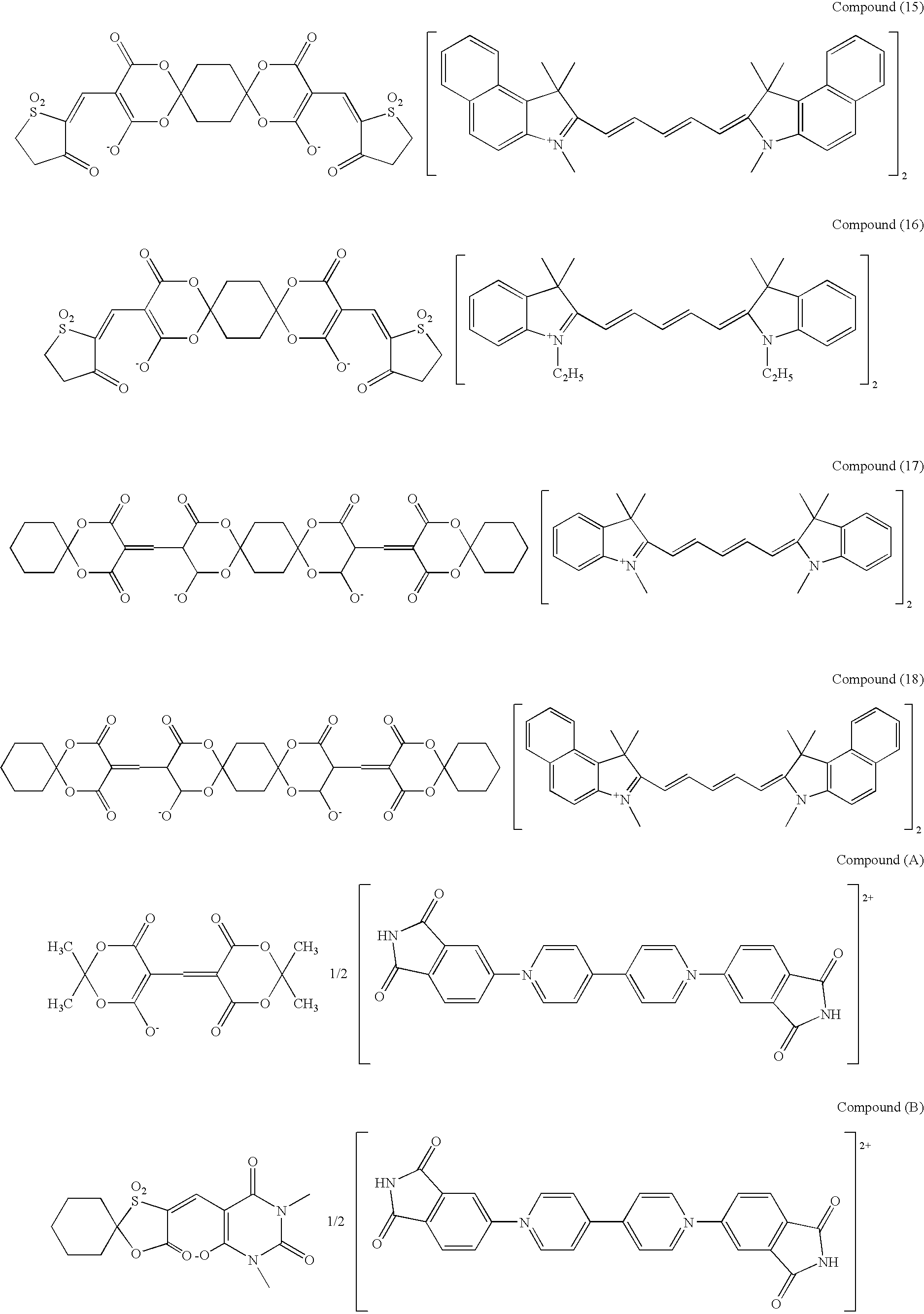 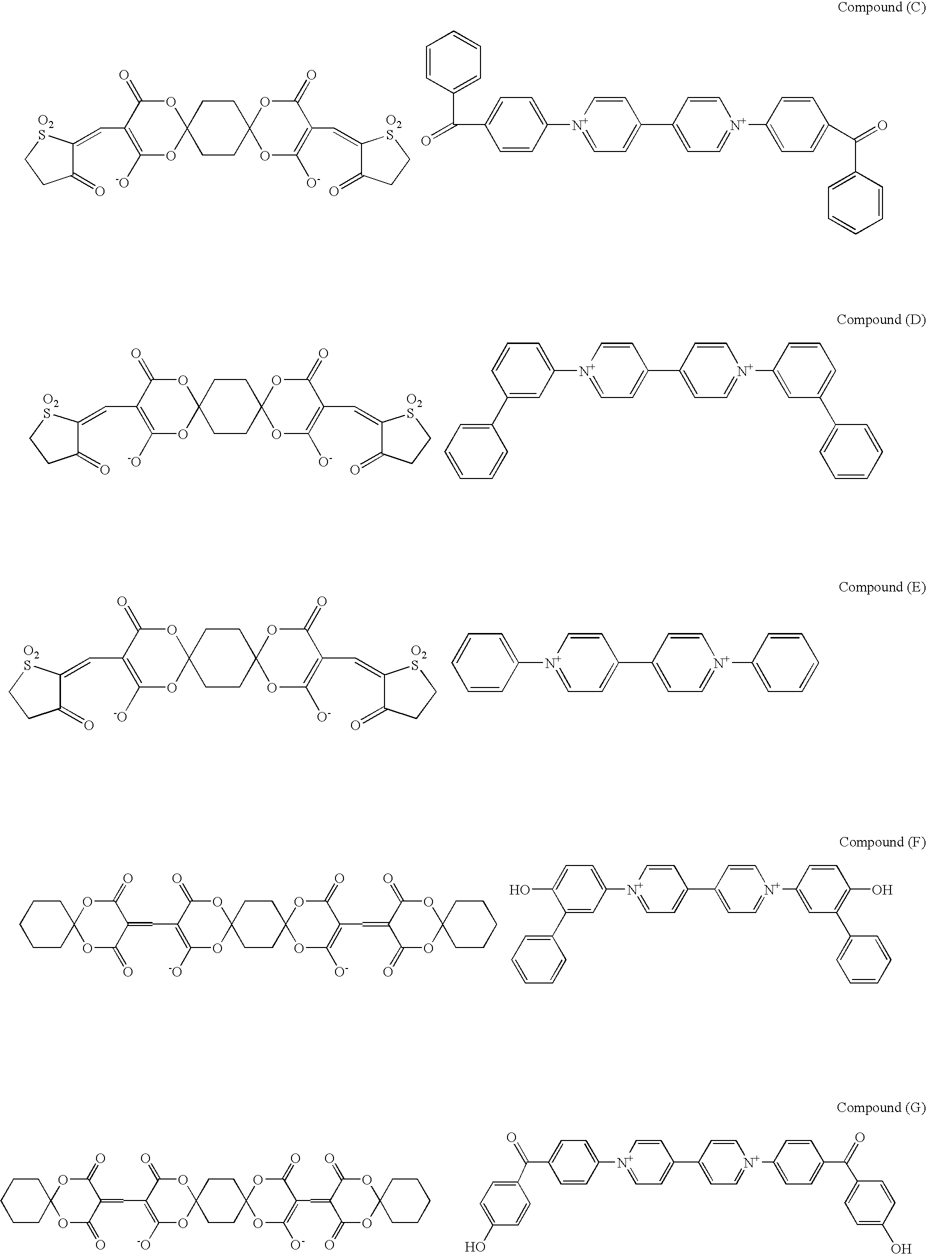
Evaluation of Optical Information Recording Medium 1:
(1) Evaluation of Recording and Reproduction

Signal (2T) of 0.16 μm was recorded and reproduced with each of the manufactured optical information-recording media with a recording/reproducing evaluator loading 403 nm laser, NA 0.85 pickup (DDU1000, manufactured by Pulse Tech Products Corporation), at clock frequency 66 MHz and linear velocity 5.28 m/s. Further, each of the optical information-recording media after recording was irradiated with an Xe lamp (170,000 lux) for 24 hours and then reproduced. In the evaluation, the optical recording method of the invention was used. Recording was performed on the groove. The results obtained are shown in Table 2 below.

TABLE 2

| | | | Recording/Reproducing | Recording/Reproducing |
|---|---|---|---|---|
| | | | Characteristics | Characteristics |
| | | Recording | (before irradiation | (after irradiation |
| | | Power | with Xe lamp) | for 24 hours) |
| Example No. | Compound | (mW) | Read Out of Pit | Read Out of Pit |
| Example 1 | Compound (1) | 3.5 | Possible | Possible |
| Example 2 | Compound (6) | 3.0 | Possible | Possible |
| Comparative | Compound (A) | 3.5 | Possible | Impossible |
| Example 1 | | | | |
| Comparative | Compound (B) | 3.0 | Possible | Impossible |
| Example 2 | | | | |

From the above results in Table 2, it can be seen that both optical information-recording media of the invention are capable of reproduction after irradiation with Xe lamp for 24 hours after recording, as compared with conventional media using a discoloration inhibitor and a mixture as the counter salt, so that light fastness is conspicuously improved.

Further, Compounds (15) and (16) were compared with Comparative Compounds (C) to (E), and Compounds (17) and (18) were compared with Compounds (F) and (G); as a result, the solubility in 2,2,3,3-tetrafluoropropanol was poor for Comparative Examples 3 to 7 where bipyridinium cation was contained, failing in producing a disc, but in Examples 3 to 6 having a cyanine as the counter cation exhibited good solubility, disc production was possible without accompanying any difficulty at all.

TABLE 3

| | | | Disc |
|---|---|---|---|
| Example No. | Compound | Solubility | Production |
| Example 3 | Compound (15) | Good | Capable |
| Example 4 | Compound (16) | Good | Capable |
| Example 5 | Compound (17) | Good | Capable |
| Example 6 | Compound (18) | Good | Capable |
| Comparative Example 3 | Compound (C) | Poor | Incapable |
| Comparative Example 4 | Compound (D) | Poor | Incapable |
| Comparative Example 5 | Compound (E) | Poor | Incapable |
| Comparative Example 6 | Compound (F) | Poor | Incapable |
| Comparative Example 7 | Compound (G) | Poor | Incapable |

As regards the solubility evaluation in Table 3, such compounds that dissolve in 2,2,3,3-tetrafluoropropanol in 1% by mass or more were expressed as ‘good’, and those insoluble therein were expressed as ‘poor’. The solubility evaluation was held at 25° C. after irradiating ultrasonic wave for 30 minutes.

From the above results in Table 3, it is seen that the solubility and the disc production aptitude on both optical information-recording media of the invention are remarkably enhanced, as compared with conventional media using a discoloration inhibitor and a mixture as the counter salt. Further, instead of Compound 3 in Example 3, Compounds (2-1), (2-4), (2-10), (3-1), (3-4), (3-10), (4-1), (4-4), (4-10), (5-1), (5-4) and (5-10) were used for disc production. As a result, the solubility was sufficiently good as in Example 3 and a disc could be produced without accompanying any difficulty.

### INDUSTRIAL APPLICABILITY

By the use of the compounds according to the invention in a recording layer, it is possible to manufacture an optical information-recording medium capable of recording information by irradiation with laser beams of from 400 to 410 nm without impairing recording characteristics having high press life and durability after recording.

1. An optical information-recording medium comprising:
a substrate; and
a recording layer capable of recording of information by irradiation with laser beams of wavelengths of from 400 to 410 nm,
wherein the recording layer comprises an oxonol dye represented by formula (1), and a counter cation of the oxonol dye (i.e., Y^{t+} in formula (1)) is a cyanine cation: 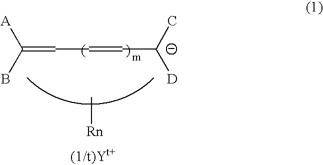
wherein A, B, C and D each represents an electron attractive group, wherein the sum total of Hammett's σp values of A and B, and the sum total of Hammett's σp values of C and D are respectively 0.6 or more, and A and B, or C and D may be linked with each other to make a ring; R represents a substituent on carbon of methine; m represents an integer of 0 or 1; n represents an integer of from 0 to 2m+1, and when n represents an integer of 2 or more, a plurality of R's may be the same or different, and they may be linked with each other to form a ring; Y^{t+} represents a t-valent cyanine cation; and t represents an integer of from 1 to 10.

2. The optical information-recording medium as claimed in claim 1,
wherein the oxonol dye is represented by formula (2): 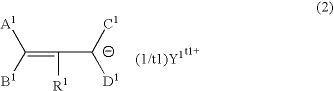
wherein A¹, B¹, C¹ and D¹ each represents an electron attractive group, wherein the sum total of Hammett's σp values of A¹ and B¹, and the sum total of Hammett's σp values of C¹ and D¹ are respectively 0.6 or more, and A¹ and B¹, or C¹ and D¹ may be linked with each other to make a ring; R¹ represents a hydrogen atom or a substituent on carbon of methine; Y^{1t+} represents a t1-valent cyanine cation; and t1 represents an integer of from 1 to 10.

3. The optical information-recording medium as claimed in claim 1,
wherein the cyanine cation is represented by formula (3) or (4): 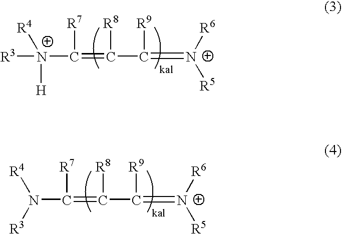
in formulae (3) and (4), R³ to R⁹ each represents a hydrogen atom or a substituent, and R³ to R⁹ may be linked with each other to form a ring; and ka1 represents an integer of from 0 to 3, and when ka1 is 2 or more, a plurality of R⁸'s and R⁹'s may be the same or different.

4. The optical information-recording medium as claimed in claim 1,
wherein the cyanine cation is represented by formula (5): 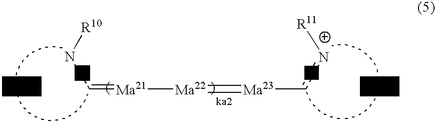
wherein Za²¹ and Za²² each independently represents an atomic group to form a heterocyclic ring; Ma²¹, Ma²² and Ma²³ each independently represents a substituted or unsubstituted methine group; ka2 represents an integer of from 0 to 3, and when ka is 2 or more, a plurality of Ma²¹'s and Ma²²'s may be the same or different; and R¹⁰ and R¹¹ each independently represents a substituent.

5. The optical information-recording medium as claimed in claim 4, wherein the cyanine cation represented by formula (5) is represented by formula (6): 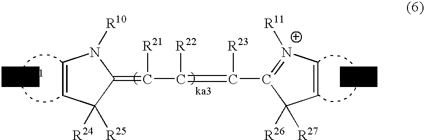
wherein Za³¹ and Za³² each independently represents an atomic group to form a carbocyclic ring or a heterocyclic ring; R¹⁰ and R¹¹ have the same meaning as R¹⁰ and R¹¹ in formula (5); R²¹, R²², R²³, R²⁴, R²⁵, R²⁶ and R²⁷ each represents a hydrogen atom or a substituent; and ka3 represents an integer of from 0 to 3, and when ka3 is 2 or more, a plurality of R²¹'s and R²²'s may be the same or different.

6. The optical information-recording medium as claimed in claim 1, further comprising
a light reflective layer comprising a metal.

7. The optical information-recording medium as claimed in claim 1, further comprising
a protective layer.

8. The optical information-recording medium as claimed in claim 1,
wherein the substrate is a transparent disc-like substrate having a pre-groove having track pitch of from 0.2 to 0.5 μm on the surface of the transparent disc-like substrate, and
the recording layer is provided on the surface of the side on which the pre-groove is provided.
